(19) United States
(12) Patent Application Publication
(10) Pub. No.: US 2002/0181051 A1
(43) Pub. Date: Dec. 5, 2002

(54) Optical transmitter/receiver

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/148,866

(22) PCT Filed: Dec. 7, 2000
(86) PCT No.: PCT/JP00/08647

(30) Foreign Application Priority Data
Dec. 9, 1999 (JP) 11-350016

(51) Int. Cl. H04B 10/00

(52) U.S. Cl. 359/152; 359/154

(57) ABSTRACT

An optical transmitter/receiver is provided which has a fast main transmission channel and a slow sub transmission channel, which sub transmission channel is used for control purposes. The optical transmitter/receiver is provided with a transmission unit for generating an optical signal that superimposes a broadband signal for a main transmission channel on a narrowband signal for a sub transmission channel. The broadband signal has a blank region formed in its power spectrum and is encoded in a redundant format. The power spectrum of the narrowband signal is formed in the blank region of the main broadband signal. Further, the transmission power of the broadband signal is greater than that of the narrowband signal Accordingly, it is possible to reduce cross-modulation that originates in the limiter used for gain control, and to make equal the receiving conditions of the main transmission channel and a sub transmission channel.

### TECHNICAL FIELD

The present invention relates to an optical transmitter/receiver used in optical communications.

### BACKGROUND ART

FIG. 9 shows the general construction of a conventional optical transmitter/receiver used in optical communications. The transmitter/receiver of FIG. 9 includes a laser diode 101, a laser diode drive circuit 110 for driving current through the laser diode 101, an optical fiber 111 via which optical signals are transmitted from the laser diode 101. A portion of the optical signal from the laser diode 101 is also transmitted to a monitor photodiode 102 for converting the optical signal to an optical current. A comparator 104 compares this optical current to the value specified by a variable resistor 105 provided for setting the optical intensity. The result of the comparison by the comparator 104 is transmitted to the drive circuit 110 to control the strength of the optical signal. This mechanism is an analog auto power control (APC) circuit. Further, a data signal input line 112 is connected to the drive circuit 110. The drive circuit 110 modulates the current in the laser diode 101 based on transmission data received via the input line 112.

In the architecture of an optical fiber communication system, control signals must occasionally transmitted to control flow and the like during the data transmission process. Ordinarily, these control signals can be transmitted at a slower rate than the data transmission rate. However, the optical transmitter/receiver described above can be designed with only a single transmission channel. In order to create a plurality of transmission channels, either multiple transmitter/receivers must be arrayed in parallel or a wavelength multiplexing technology must be used. These methods are very expensive for the transmission of control signals.

### DISCLOSURE OF THE INVENTION

In view of the foregoing, it is an object of the present invention to provide an optical transmitter/receiver combining a main high-speed transmission channel with a low-speed transmission channel for control use.

These objects and others will be attained by an optical transmitter/receiver provided with a transmission unit for generating an optical signal that superimposes a broadband signal for a main transmission channel on a narrowband signal for a sub transmission channel. The broadband signal has a blank band in its power spectrum and is encoded in a redundant format. The power spectrum of the narrowband signal is formed in the blank region of the main broadband signal. Further, the transmission power of the broadband signal is greater than that of the narrowband signal.

The gain control circuit at optical receiver should also be realized by limiting method Further, the ratio of transmission powers for the main transmission channel and the sub transmission channel should be set approximately equivalent to the ratio of minimum reception sensitivities for the same. Further, the signal for the sub transmission channel should be encoded in a redundant format, and at least one new transmission channel should be provided in the blank region of the power spectrum formed by the sub transmission channel.

With this construction, the transmission power of the sub transmission channel is set smaller than that of the main transmission channel. Accordingly, it is possible to reduce cross-modulation that originates in the limiter used for gain control. This configuration provides meets all conditions necessary for simultaneous reception via the main and sub transmission channels and can be adapted to perform transmission with three or more channels.

According to another aspect of the present invention, an optical transmitter/receiver is provided with a transmission unit for generating an optical signal that superimposes a broadband signal for a main transmission channel on a narrowband signal for a sub transmission channel. The broadband signal is encoded in a format with little redundancy, while the narrowband signal is encoded with a spread spectrum method in a spectrum region overlapping the power spectrum of the main transmission channel. Further, the transmission power of the broadband signal is greater than that of the narrowband signal.

With this construction, the spread spectrum signal appears as noise to the signal of the main transmission channel and may slightly increase the error rate for that channel, but this signal can be reliably recovered. The spread spectrum signal for the sub transmission channel can also be reliably demodulated under the main signal. As a result, a sub transmission channel can be simply constructed by employing signal encoding format with little redundancy.

These and other features of the present invention will be described in more detail below with reference to the drawings and within the scope of the attached claims.

### BRIEF DESCRIPTION OF THE DRAWINGS

FIG. 1 is a block diagram showing an optical transmitter/receiver according to a first embodiment of the present invention;

FIG. 2 is a graph of the signal spectrum, which shows the principles of a first embodiment of the present invention;

FIG. 3 is a circuit diagram showing the internal construction of a photodiode transimpedance amplifier;

FIG. 4 is an explanatory diagram showing the signal waveforms on the transmission end;

FIG. 5 is an explanatory diagram showing the signal waveforms on the reception end;

FIG. 6 is an explanatory diagram showing the signal waveforms on the reception end of a conventional optical transmitter/receiver;

FIG. 7 is a block diagram showing an optical transmitter/receiver according to a second embodiment of the present invention;

FIG. 8 is a graph of the signal spectrum, which shows the principles of a second embodiment of the present invention; and

FIG. 9 is a block diagram showing a conventional optical transmitter.

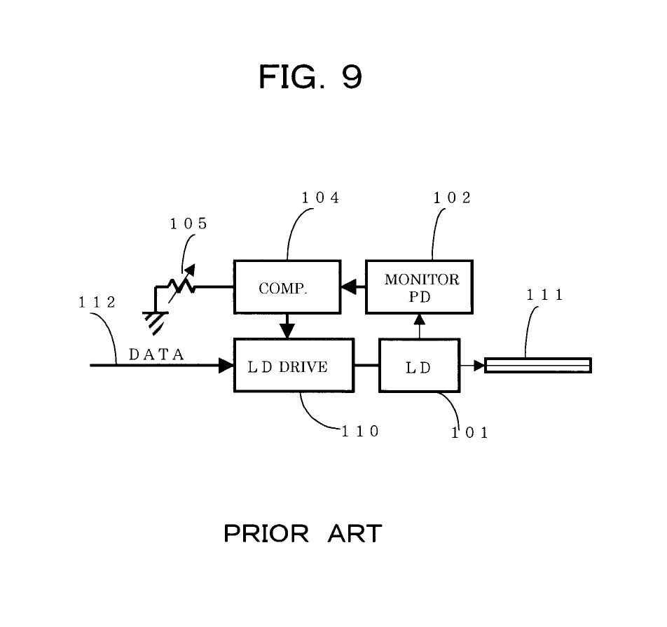

### BEST MODE FOR CARRYING OUT THE INVENTION

An optical transmitter/receiver according to preferred embodiments of the present invention will be described while referring to the accompanying drawings.

### First Embodiments

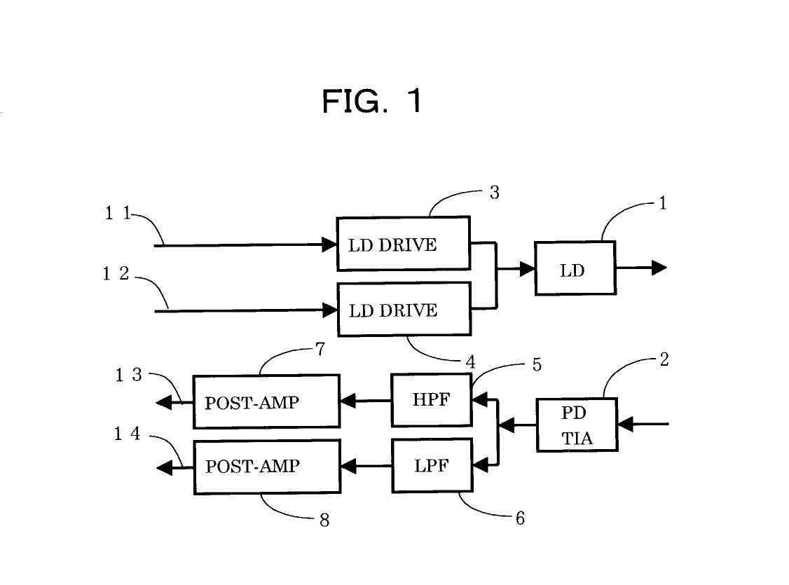

FIG. 1 is a block diagram showing an optical transmitter/receiver according to a first embodiment of the present invention. Data for a main transmission channel is transmitted via a main transmission channel input terminal 11 to a laser diode drive circuit 3. Data for a sub transmission channel is transmitted via a sub transmission channel input terminal 12 to a laser diode drive circuit 4. The modulated currents from the laser diode drive circuit 3 and laser diode drive circuit 4 are added to drive a laser diode 1. The APC (Auto Power Control) circuit is not shown in FIG. 1.

An optical signal transmitted to a photodiode transimpedance amplifier 2 via an optical fiber (not shown) is converted into an electrical signal through photoelectric transfer and amplified by the photodiode transimpedance amplifier 2. The electrical signal is split by a high-pass filter 5 and a low-pass filter 6. The waveforms of each signal which are output of each filter are shaped by a post-amp 7 and a post-amp 8, respectively. The signal output from the post-amp 7 is the reception signal for the main transmission channel and is transmitted via a main transmission channel output terminal 13. The signal output from the post-amp 8 is the reception signal for the sub transmission channel and is transmitted via a sub transmission channel output terminal 14.

The signal transmitted to the main transmission channel is a 1-Gbps signal encoded with the 8B/10B encoding scheme, while the signal transmitted to the sub transmission channel is a 50 Mbps signal encoded with the 4B/5B encoding scheme.

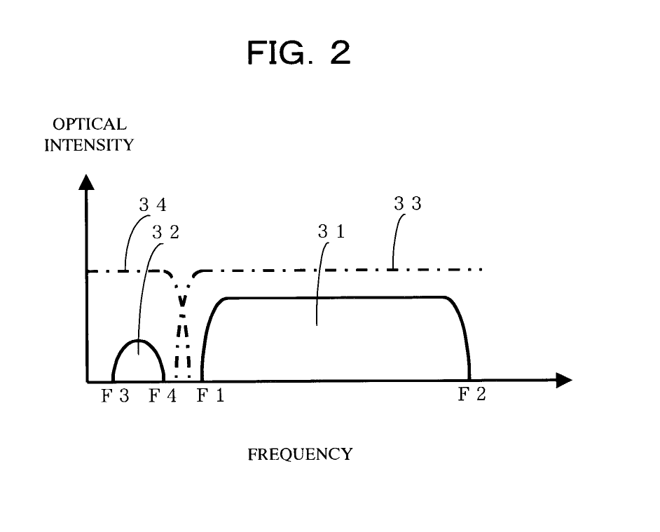

FIG. 2 is a graph showing the operating principles of the present invention. The X-axis of the graph represents frequency, while the Y-axis of the graph represents optical intensity. Since the 8B/10B code is an encryption form using redundancy, a blank band of power spectrum exists in the low-frequency range. That is,a power spectrum 31 for the main transmission channel exists in the range between a lower limit F1 and an upper limit F2. A power spectrum 32 for the sub transmission channel exists in the range between a lower limit F3 and an upper limit F4. A transmission rate and encoding format for the main and sub transmission channels are chosen such that F1 is greater than F4. Since the power spectrums 31 and 32 do not overlap, they can be separated by suitable filters. The reference numerals 33 and 34 represent the filter characteristics of the high-pass filter 5 and low-pass filter 6, respectively.

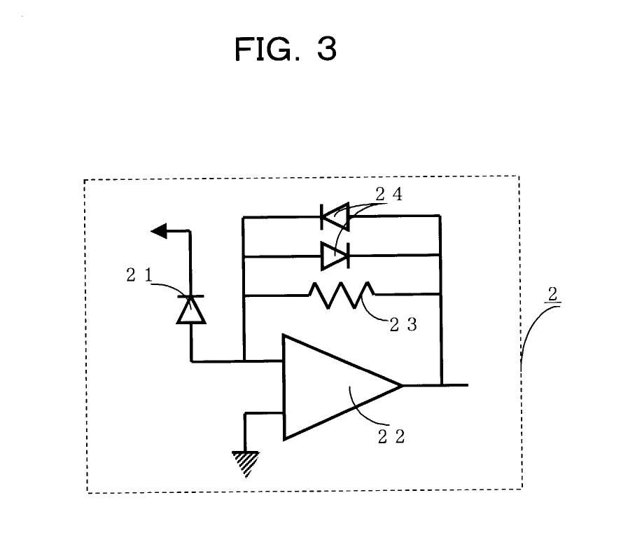

FIG. 3 shows the internal construction of the photodiode transimpedance amplifier 2 in FIG. 1. A photodiode 21 outputs an optical current. The optical current is amplified and converted into a voltage output by a transimpedance amp 22. The function of the transimpedance amp 22 is equivalent to that of an operational amplifier. A feedback resister 23 determines the conversion rate of input current to output voltage. A pair of clamp diodes 24 is connected in parallel to the feedback resister 23. The clamp diodes 24 function as a type of gain control to limit the output voltage for a large input signal current within a prescribed value.

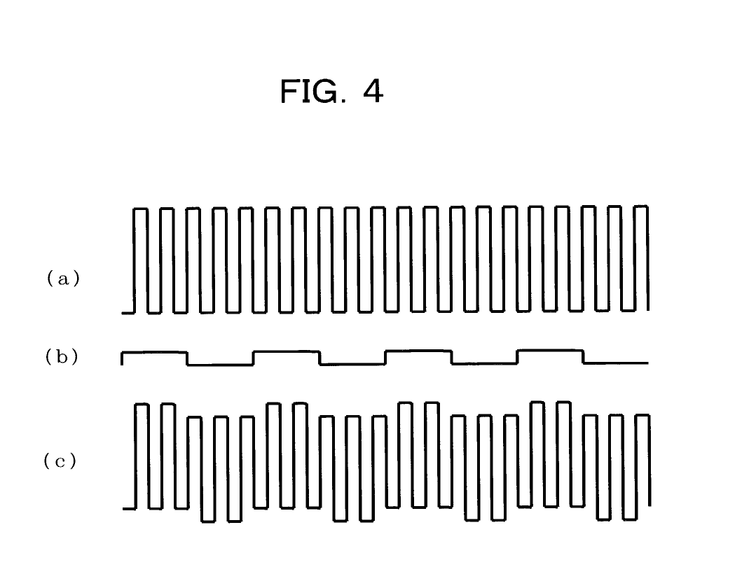

Next, the behavior of the optical transmitter/receiver will be described with reference to FIGS. 4 through 6. FIG. 4 shows the waveforms indicating the behavior of signals on the transmission end. FIG. 4(a) is the waveform of the current which is output of the laser diode drive circuit 3, that is, the waveform of the signal in the main transmission channel. FIG. 4(b) shows the waveform of the current which is output of the laser diode drive circuit 4, that is, the waveform for the signal in the sub transmission channel. FIG. 4(c) shows the waveform of the drive current applied to the laser diode 1. FIG. 4(c) is the result of adding signals in FIG. 4(a) and FIG. 4(b). As shown in the diagram, the current is large in the main transmission channel and small in the sub transmission channel. This is one feature of the present invention.

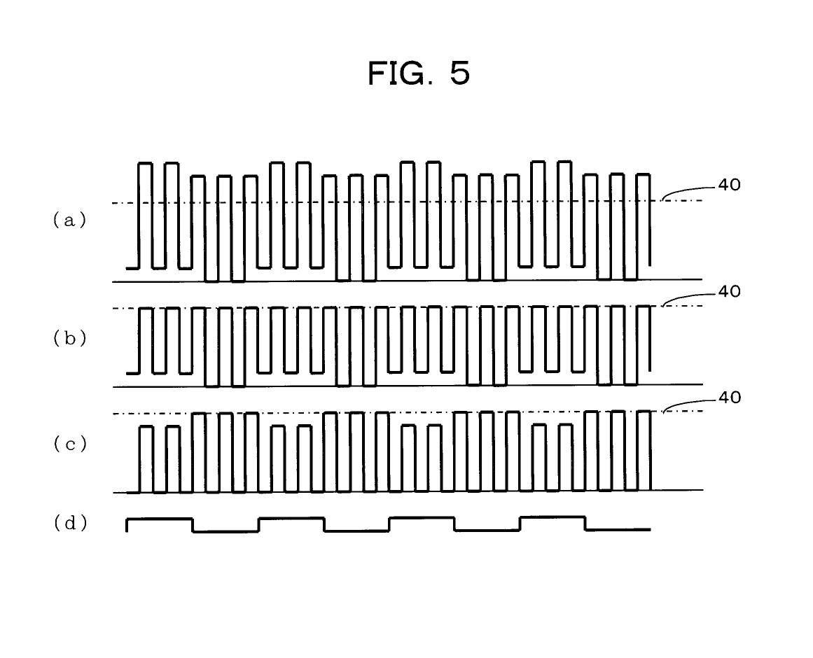

FIG. 5 shows signal waveforms that indicate the behavior on the receiving end. FIG. 5(a) shows the optical current received from the photodiode 21. FIG. 5(b) shows the output voltage from the transimpedance amp 22. Here, the clamp diodes 24 limit the output of a transimpedance amp 22 to a level 40. FIG. 5(c) shows the output voltage from the high-pass filter 5. FIG. 5(d) shows the output voltage from the low-pass filter 6. Since it has a wave shaping function, the post-amp can remove any variations in amplitude of the degree shown in FIG. 5(c).

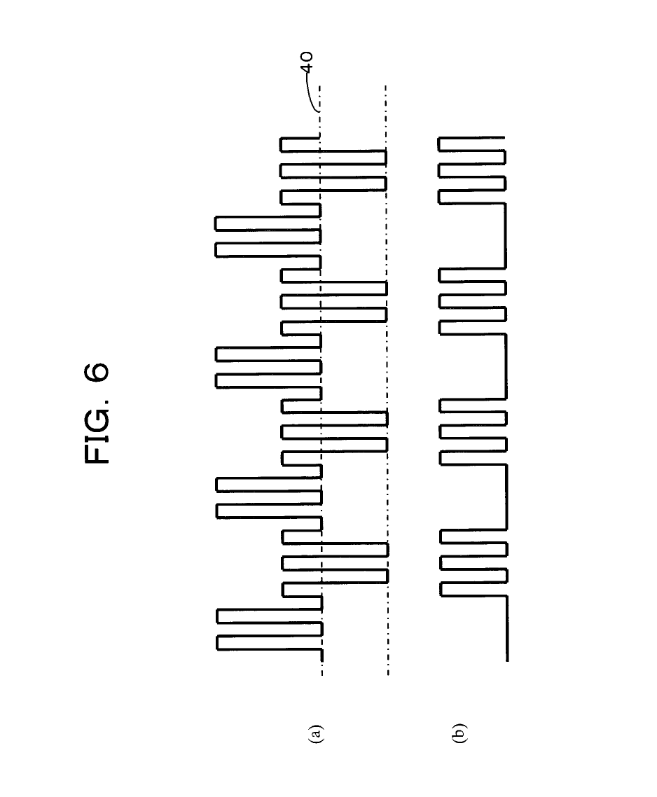

FIG. 6 shows the behavior on the reception end of the conventional optical transmitter/receiver. This example assumes that the level of the signals in the main and sub transmission channels are approximately the same. Further, a large signal is applied to the receiving end. FIG. 6(a) shows the optical current received from the photodiode 21. As described in FIG. 5, the signal output is limited to the level 40. Accordingly, the output from the transimpedance amp 22 is equivalent to that shown in FIG. 6(b). As shown, the signal for the main transmission channel is lost in certain intervals due to the effect of cross-modulation.

Since signals transmitted at a high rate have a broadband spectrum, the minimum reception sensitivity is high. Inversely, since signals transmitted at a low rate have a narrowband spectrum, the minimum reception sensitivity can be set at a low value. The present invention, using this quality, employs a ratio of minimum sensitivity between the main and sub transmission channels that is roughly proportional to the ratio of transmission power. Hence, the present invention can be configured to receive signals from the main and sub transmission channels simultaneously and can prevent signal loss to non-linearity of the transimpedance amp, as shown in FIG. 6. There is also concern that laser light could be emitted into free space when an optical fiber becomes disconnected in the optical transmitter/receiver and cause damage to human eyes. Therefore, it is necessary to minimize the transmission power. The present invention suitably addresses this point.

There are various conceivable applications for the optical transmitter/receiver of the present invention since the optical transmitter/receiver can provide both a broadband main transmission channel and a narrowband sub transmission channel. For example, it is conceivable that the sub transmission channel could be used for flow control and access control of the main transmission channel. The sub transmission channel could also be used to measure the distance between terminals or could be constructed as an interlock system for detecting fiber disconnections. Another possible construction of the optical transmitter/receiver is that of a network system combining the features of a plurality of protocols, wherein the main transmission channel employs a time-sharing control protocol and the sub transmission channel employs a contention protocol.

The optical transmitter/receiver of the present invention can be constructed with three or more channels having differing bands as required for the application.

### Second Embodiment

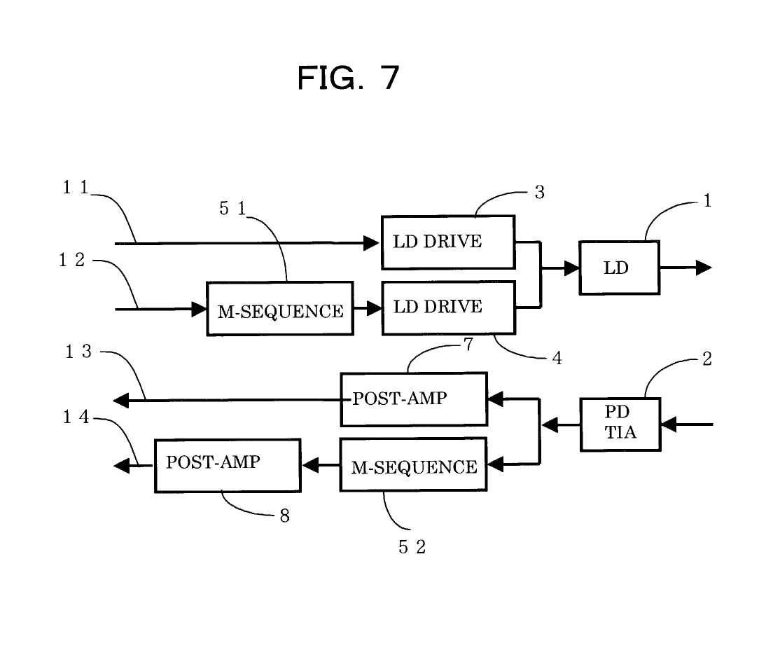

FIG. 7 is a block diagram showing the construction of an optical transmitter/receiver according to a second embodiment of the present invention, wherein like parts and components are designated by the same reference numerals to avoid duplicating description. Data for the main transmission channel is transmitted to the laser diode drive circuit 3 via the input terminal 11. Data for the sub transmission channel is transmitted to the laser diode drive circuit 4 via the input terminal 12 and an M-sequence encoder 51. The modulated currents from the laser diode drive circuit 3 and laser diode drive circuit 4 are added together to drive the laser diode 1. The APC circuit is not shown in FIG. 7 either.

An optical signal transmitted through an optical fiber (not shown) is converted to electric signals and amplified by the photodiode transimpedance amplifier 2 and transmitted to the post-amp 7 and a M-sequence decoder 52. Output from the post-amp 7 is sent via the output terminal 13 as a reception signal for the main transmission channel. Output from the M-sequence decoder 52 is transmitted to the post-amp 8. The output from the post-amp 8 is transmitted via the output terminal 14 as a reception signal for the sub transmission channel.

Signals transmitted for the main transmission channel are 2.488-Gbps signals encoded using the SONET (Synchronous Optical Network) format. Signals sent for the sub transmission channel are spread spectrum signals using the M-sequence encoding method.

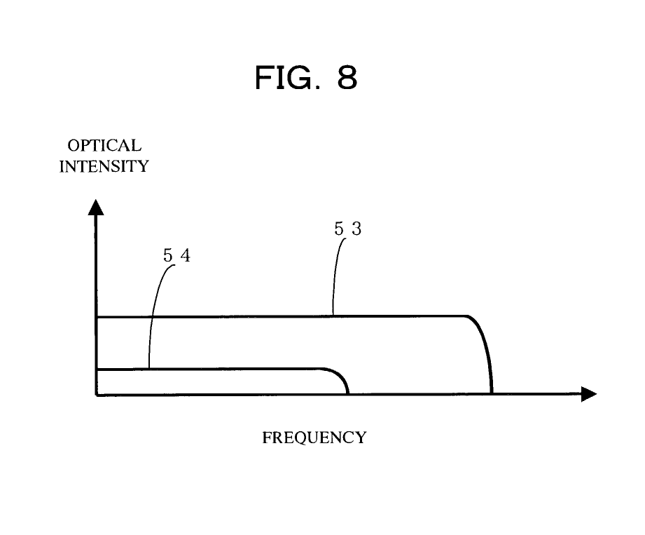

FIG. 8 is a graph showing the operation principles of the present embodiment. In the graph, the X-axis represents frequency, while the Y-axis represents the optical intensity. Unlike the 8B/10B encryption method of the first embodiment, the SONET encoding method uses almost no redundancy. Therefore, almost no blank power spectrum regions exist in the lower frequencies. In the diagram, the spectrum 53 is the power spectrum of the main transmission channel, while the spectrum 54 is that of the sub transmission channel. The spread spectrum signal for the sub transmission channel can be demodulated even should the signal overlap the spectrum 53. From the perspective of the main transmission channel, the signal of the sub transmission channel is equivalent to noise. Therefore, the existence of the sub transmission channel will slightly worsen the S/N ratio of the main transmission channel and increase its error rate to a degree. However, the optical transmitter/receiver of the present embodiment enables construction of a sub transmission channel when employing an encryption method such as SONET, which does not use redundancy.

### Industrial Applicability of the Invention

The present invention achieves at a low cost an optical transmitter/receiver capable of conducting simultaneous communications with a broadband main transmission channel and a narrowband sub transmission channel, while preventing cross-modulation between the two. The present invention also provides a low cost optical transmitter/receiver capable of performing communications with overlapping signals for the main and sub transmission channels. In this configuration, the signal for the sub transmission channel is encoded according to a spread spectrum method in region that overlaps the main transmission spectrum.

1. An optical transmitter/receiver comprising a transmission unit for generating an optical signal that superimposes a broadband signal for a main transmission channel, the signal having a power spectrum with a blank region and being encoded in a redundant format, on a narrowband signal for a sub transmission channel, the signal having a power spectrum in the blank region of the main broadband signal, wherein the transmission power of the broadband signal is greater than that of the narrowband signal.

2. An optical transmitter/receiver as recited in claim 1, further comprising a reception unit that performs gain control by a limiting method.

3. An optical transmitter/receiver as recited in claim 1, wherein the ratio of transmission powers for the main transmission channel and the sub transmission channel is set approximately equivalent to the ratio of minimum reception sensitivities for the same.

4. An optical transmitter/receiver as recited in claim 1, wherein the signal for the sub transmission channel is encoded in a redundant format, and at least one new transmission channel is provided in the blank region of the power spectrum formed by the sub transmission channel.

5. An optical transmitter/receiver comprising a transmission unit for generating an optical signal that superimposes a broadband signal for a main transmission channel, the signal having a power spectrum with a blank region and being encoded in a redundant format, on a narrowband signal for a sub transmission channel, the signal having a power spectrum in the blank region of the main broadband signal.

6. An optical transmitter/receiver comprising a transmission unit for generating an optical signal that superimposes a broadband signal for a main transmission channel on a narrowband signal for a sub transmission channel, the broadband signal having being encoded in a format with little redundancy, and, the narrowband signal being encoded with a spread spectrum method in a spectrum region overlapping a power spectrum of the main transmission channel, wherein the transmission power of the broadband signal is greater than that of the narrowband signal.

7. An optical transmitter/receiver comprising a transmission unit for generating an optical signal that superimposes a broadband signal for a main transmission channel on a narrowband signal for a sub transmission channel, the broadband signal being encoded in a format with little redundancy, and, the narrowband signal being encoded with a spread spectrum method in a spectrum region overlapping the power spectrum of the main transmission channel.

8. An optical transmitter/receiver comprising an optical transceiver having a broadband main transmission channel used for transmitting signals and a narrowband sub transmission channel used for flow control and access control of the main transmission channel.

9. An optical transmitter/receiver of a terminal for communicating another terminal, comprising a broadband main transmission channel and a narrowband sub transmission channel, the narrowband sub channel being used for measuring distance between the terminal and the another terminal.

10. An optical transmitter/receiver for performing optical communications using optical fibers, comprising an optical transceiver having a broadband main transmission channel and a narrowband sub transmission channel; and an interlock system that employs the sub transmission channel to detect disconnections in the optical fibers.
